(19) United States
(12) Patent Application Publication
(10) Pub. No.: US 2013/0107785 A1
(43) Pub. Date: May 2, 2013

(54) TRACKING LOOP ENHANCEMENTS FOR MITIGATING SIGNAL INTERFERENCE AND ADJUSTING SIGNAL POWER

(71) Applicants: Kapil Bhattad, Bangalore (IN); Tao Luo, San Diego, CA (US); Taesang Yoo, San Diego, CA (US); Shivratna G. Srinivasan, San Diego, CA (US)

(72) Inventors: Kapil Bhattad, Bangalore (IN); Tao Luo, San Diego, CA (US); Taesang Yoo, San Diego, CA (US); Shivratna G. Srinivasan, San Diego, CA (US)

(73) Assignee: QUALCOMM Incorporated, San Diego, CA (US)

(21) Appl. No.: 13/447,067

(22) Filed: Apr. 13, 2012

Related U.S. Application Data
(60) Provisional application No. 61/554,877, filed on Nov. 2, 2011.

(51) Int. Cl. H04W 4/00; H04H 20/71

(52) U.S. Cl. 370/312; 370/328

(57) ABSTRACT

A method, an apparatus, and a computer program product for wireless communication are provided for maintaining a time tracking loop (TTL) to increase an overall signal-to-noise ratio (SNR) of a signal. The signal includes a series of consecutive symbols, received via multiple signal paths with different delays in a subframe. When attempting to decode the signal, only part of a symbol for a signal path may be captured in a fast Fourier transform (FFT) window due to the multiple signal path delays, leading to inter-channel interference (ICI), inter-symbol interference (ISI), and/or power loss. The SNR may be increased by optimizing a FFT window position when decoding the signal. An optimal FFT window position may be based on a subframe type. Moreover, the SNR may be increased by performing a linear operation on samples of the symbol prior to performing the FFT.

### CROSS-REFERENCE TO RELATED APPLICATION(S)

This application claims the benefit of U.S. Provisional Application Ser. No. 61/554,877, entitled “TRACKING LOOP ENHANCEMENTS FOR MITIGATING SIGNAL INTERFERENCE AND ADJUSTING SIGNAL POWER” and filed on Nov. 2, 2011, which is expressly incorporated by reference herein in its entirety.

### BACKGROUND

1. Field

The present disclosure relates generally to communication systems, and more particularly, to tracking loops for mitigating signal interference and adjusting signal power.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

A transmitted signal including a series of consecutive symbols may arrive at a user equipment (UE) via multiple signal paths with different delays. When attempting to decode the signal, only part of a symbol for a signal path may be captured in a fast Fourier transform (FFT) window due to the multiple signal path delays, leading to inter-channel interference (ICI), inter-symbol interference (ISI), and/or power loss. Accordingly, a time tracking loop (TTL) may be maintained to optimize an FFT window position and increase an overall signal-to-noise ratio (SNR) by reducing ICI, reducing ISI, and/or increase signal power. Moreover, a linear operation may be performed on received samples of a symbol prior to performing the FFT to increase the SNR.

In an aspect of the disclosure, a method, an apparatus, and a computer program product for wireless communication are provided. The apparatus receives a signal including a plurality of consecutive orthogonal frequency division multiplexing (OFDM) symbols from a serving cell and at least one interfering cell in a subframe, the signal comprising a serving cell transmission from the serving cell and at least one interfering transmission from the at least one interfering cell, maintains a time tracking loop (TTL) by reducing interference in each of the received OFDM symbols, and decodes the received OFDM symbols based on the TTL. The maintaining the TTL includes determining a subframe type of the at least one interfering cell, and positioning a fast Fourier transform (FFT) window for decoding an OFDM symbol based, at least in part, on the subframe type.

Another aspect relates to the apparatus receiving a signal including a plurality of consecutive symbols, maintaining the TTL by reducing interference in each of the received symbols, and decoding the received symbols based on the TTL. The maintaining the TTL includes updating a first FFT window starting point for performing the FFT on a first symbol based on the reduced interference in the first symbol, updating a second FFT window starting point for performing the FFT on a second symbol based on the reduced interference in the second symbol, and shifting samples, corresponding to at least one of the first symbol or the second symbol, prior to performing the FFT to align frequency domain samples of the symbols within a subframe to a common subframe timing.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a diagram illustrating an example of a received signal including a sum of scaled and shifted copies of a transmitted signal.

FIG. 8 is a diagram illustrating a mismatch ratio between a received signal path and a fast Fourier transform (FFT) window hypothesis.

FIG. 9 is a diagram illustrating an example of a received signal comprising a sum of three copies of a transmitted signal arriving at a receiver via three paths.

FIGS. 10A and 10B are diagrams illustrating an example of a received signal comprising a sum of two copies of a transmitted signal arriving at a receiver via two paths.

FIG. 11 is a diagram illustrating inter-carrier interference (ICI) mitigation.

FIG. 12 is a flow chart of a method of wireless communication.

FIG. 13 is a flow chart of a method of wireless communication.

FIG. 14 is a flow chart of a method of wireless communication.

FIG. 15 is a flow chart of a method of wireless communication.

FIG. 16 is a flow chart of a method of transmitting a signal to a UE in an almost blank subframe (ABS).

FIG. 17 is a conceptual data flow diagram illustrating the data flow between different modules/means/components in an exemplary apparatus.

FIG. 18 is a conceptual data flow diagram illustrating the data flow between different modules/means/components in an exemplary apparatus.

FIG. 19 is a diagram illustrating an example of a hardware implementation for an apparatus employing a processing system.

FIG. 20 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

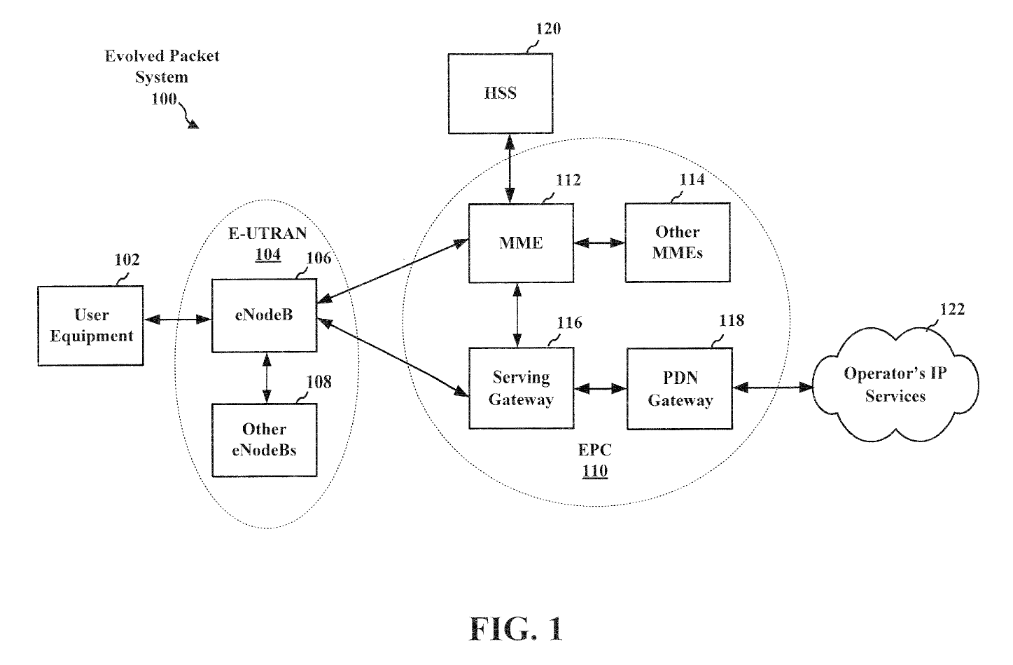

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by to the EPC 110 (e.g., via an S1 interface). The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

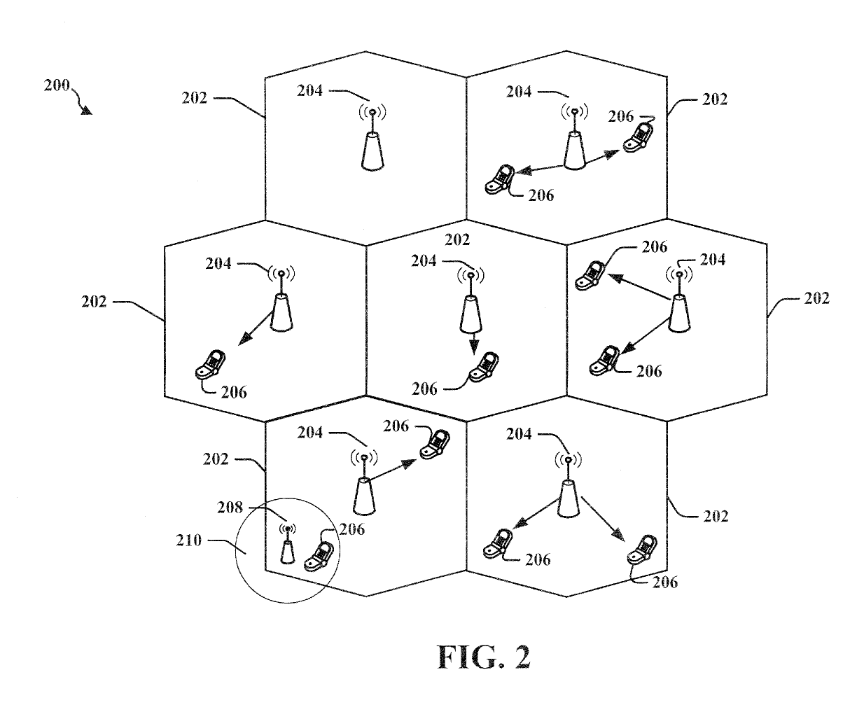

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). Alternatively, the lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

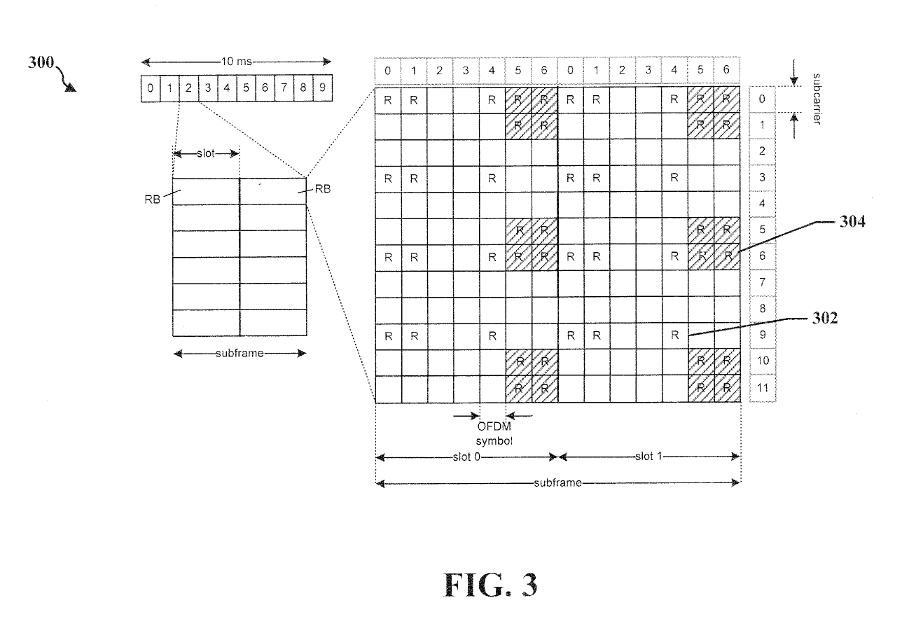

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

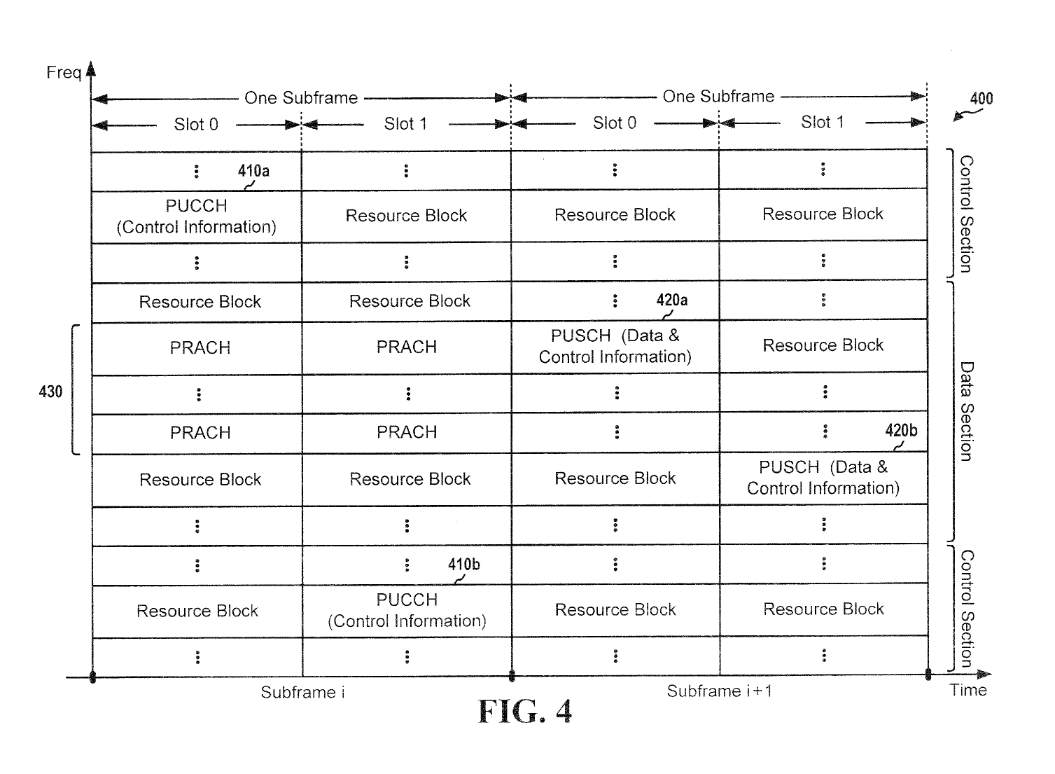

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

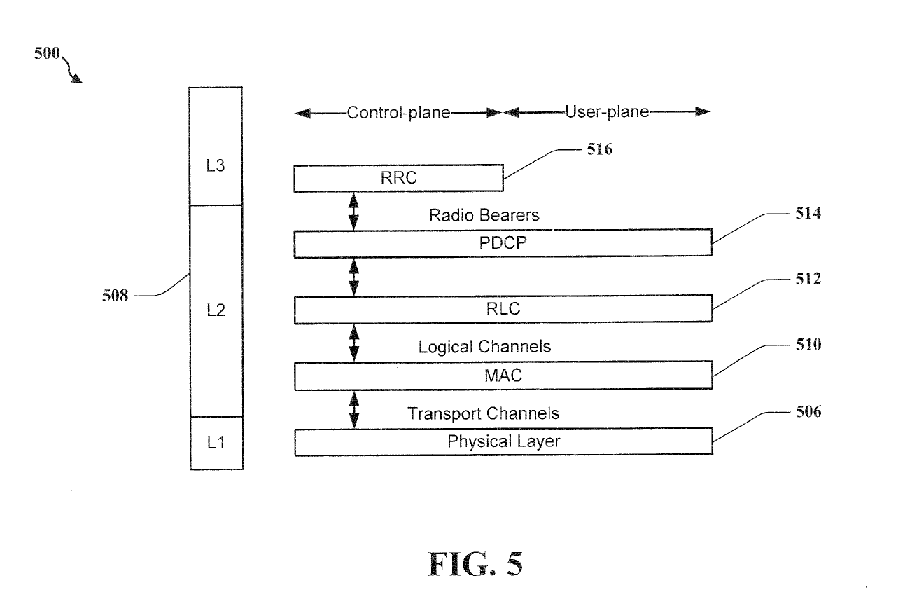

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

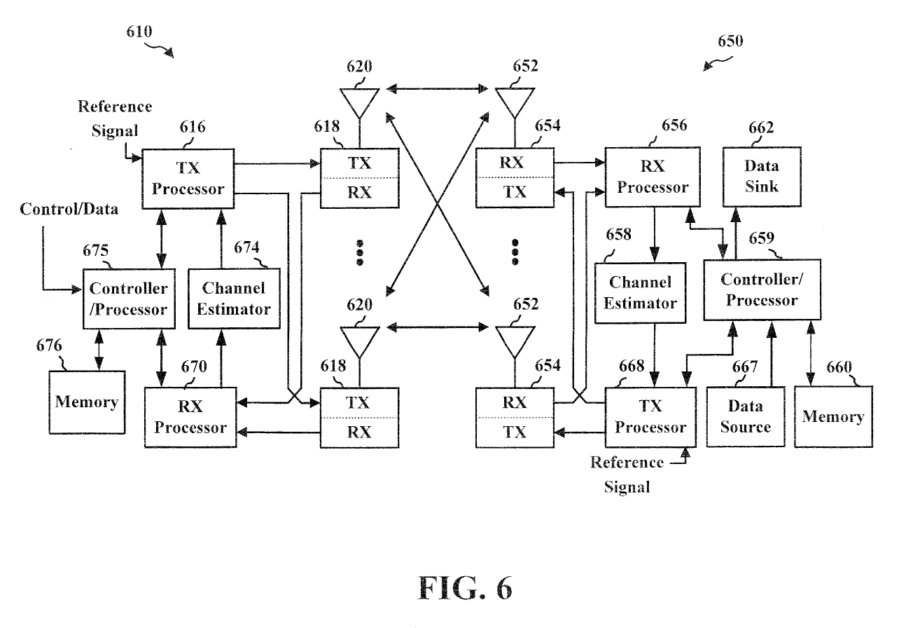

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

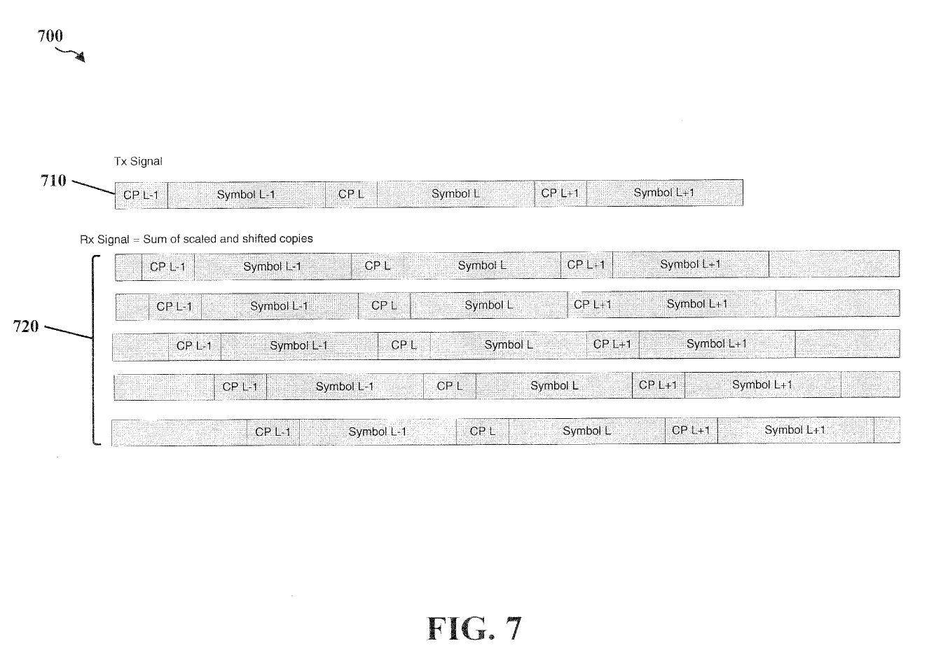

FIG. 7 is a diagram 700 illustrating an example of a received signal comprising a sum of scaled and shifted copies of a transmitted signal. In FIG. 7, the transmitted signal (Tx signal) 710 comprises a series of OFDM symbols, each symbol preceded by a cyclic prefix (CP). The transmitted signal 710 arrives at the UE via multiple paths with different delays, e.g., shifted in the time domain. Hence, the signal received signal (Rx signal) 720 comprises a sum of the multiple shifted copies of the Tx signal 720.

In an aspect, each received OFDM symbol may comprise N samples and Ncp samples corresponding to the CP portion. Therefore, an N-point FFT may be performed on the N received samples to provide N frequency-domain received samples. A phase ramp may also be applied on the N received symbols in the frequency domain to account for adjustment of an FFT window position by the TTL. For example, the phase ramp is applied by multiplying frequency domain samples by e^{jφn}, wherein n is a frequency tone index, j=sqrt(−1), and φ is proportional to the timing offset being corrected and is independent of n.

In an aspect, the UE determines the FFT window position to minimize ICI and ISI, or adjust signal power, and uses all samples within the FFT window for the FFT. The FFT window size may be equal to a corresponding symbol size, i.e., a portion of the OFDM symbol not including the CP. If all received signal path delays are within the CP, and a symbol boundary is chosen correctly, then ICI and ISI will be non-existent.

For a particular received signal path and FFT window hypothesis, a mismatch ratio d may be defined according to equation (1) below, wherein τ is the signal path delay with respect to a hypothesized FFT window position, T_{cp} is a length of the CP, and Tₛ is a length of the symbol:

$$d ( τ ) = \{ \begin{matrix}\frac{τ - {T}_{cp}}{{T}_{s}} , & τ \geq {T}_{cp} \\ 0 , & 0 \leq τ < {T}_{cp} \\ - \frac{τ}{{T}_{s}} & τ < 0\end{matrix} \qquad ( 1 )$$

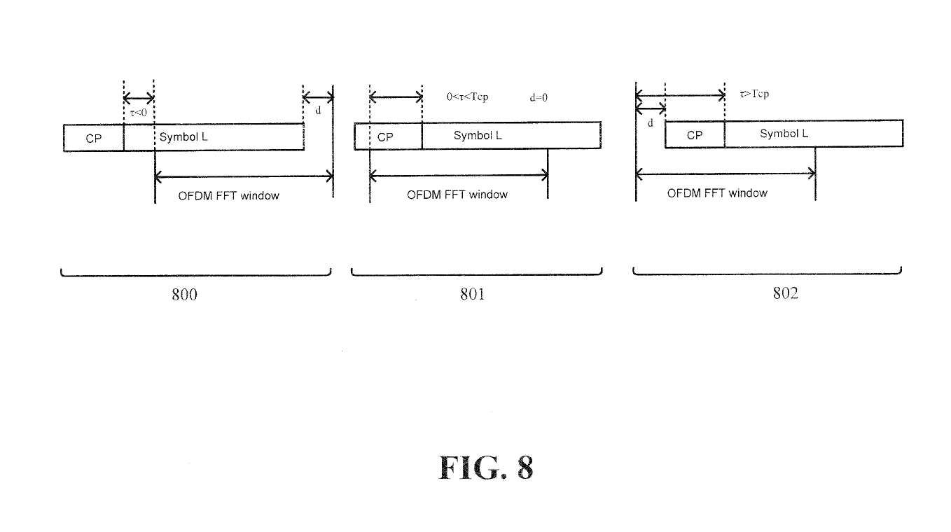

FIG. 8 includes diagrams 800, 801, and 802 illustrating the mismatch ratio d. Due to the mismatch, only part of an OFDM symbol for the signal path is captured in the FFT window leading to ISI, ICI and power loss when τ<0 or τ>T_{cp}. Hence, in an aspect, the FFT window position is optimized to account for the mismatch ratio d to increase an overall signal-to-noise ratio (SNR). Notably, if neighboring symbols are transmitted with equal power, wherein a neighboring symbol is a symbol previous to a current OFDM symbol for τ<0 and a symbol subsequent to the current OFDM symbol for τ>T_{cp}, then power, ICI, and ISI corresponding to a signal path may be calculated as follows:

Power=Power(path, current symbol)*(1−d)²; (2)

ICI=Power(path, current symbol)*d*(1−d); and (3)

ISI=Power(path, neighboring symbol)*d. (4)

As such, the overall SNR may then be calculated as follows:

SNR=(sum of power over all paths)/(sum of ICI over all paths+sum of ISI over all paths+residual noise). (5)

Therefore, the SNR can be determined with respect to the mismatch ratio d. Furthermore, the FFT window position can be optimized by determining the highest possible value of SNR.

In an aspect, the UE may receive signals from strong non-serving cells (i.e., interfering cells) transmitting only CRS and a serving cell transmitting data and CRS. Here, the non-serving (interfering) cells' CRS may be canceled using reference signal interference cancellation (RSIC). As such, power, ICI, and ISI corresponding to paths of the serving cell may be calculated as follows:

Power=Power(serving cell, path, current symbol)*(1−d)²; (6)

ICI=Power(serving cell, path, current symbol)*d*(1−d); and (7)

ISI=Power(serving cell, path, neighboring symbol)*d. (8)

Power, ICI, and ISI corresponding to paths of the interfering cells using an almost blank subframe (ABS), where only CRS is transmitted, may be determined as follows for a two transmission signal (2 Tx) case:

On symbols containing a reference signal (RS):

Power=0; (9)

ICI=Power(interfering cell, path, current symbol)*d*(1−d)/3; and (10)

ISI=0. (May be different for edge of subframe symbols, e.g., first symbol.) (11)

On symbols neighboring symbols with RS and experiencing ISI:

Power=0; (12)

ICI=0; and (13)

ISI=Power(interfering cell, path, neighboring RS symbol)*d/3. (14)

On other symbols:

Power=0; (15)

ICI=0; and (16)

ISI=0. (17)

In the above equations, the operation of dividing by 3 (“/3”) is representative of the RS density of ⅓ on OFDM symbols on which the RS is present. Hence, the RS is transmitted every three tones on OFDM symbols containing CRS. Moreover, in the above equations, it is assumed that a non-ICI/ISI portion of the interfering cells' CRS is canceled.

In an aspect, the TTL is operated to maximize the SNR. Because the ICI/ISI from an ABS pattern is different for different OFDM symbols, the optimal FFT window position is different for different OFDM symbols. Thus, to avoid phase ramping in the frequency domain, at least one OFDM symbol may be circular shifted before performing the FFT in order to have all OFDM symbols aligned to a common subframe timing for maximizing the SNR. In another aspect, a common TTL timing may be used for all OFDM symbols in the subframe and an average interference may be measured to help maximize the SNR. In a further aspect, if the ABS pattern is unknown, the TTL may be implemented on part of the subframe by performing ABS detection on a data portion of the subframe.

In an aspect, a linear operation may be performed on received samples of an OFDM symbol prior to performing FFT. For example, two different portions of the received signal may be combined before performing the FFT. Combining is useful for symbols containing RS. In another example, portions of the received signal may be scaled (e.g., by nulling, muting, amplifying, etc.). Scaling is useful for symbols neighboring symbols containing RS.

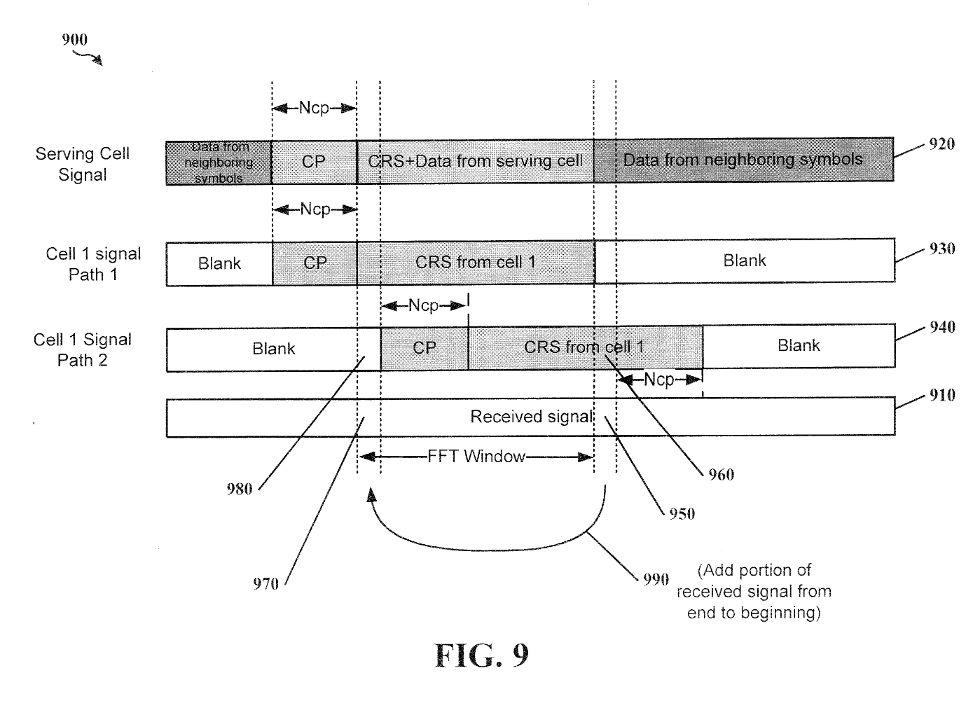

FIG. 9 is a diagram 900 illustrating an example of a received signal 910. The received signal 910 is a sum of three components. A first component is a serving signal 920 from a serving cell, a second component is a first interfering signal 930 from Cell 1 received via a first path, and a third component is a second interfering signal 940 from Cell 1 received via a second path. In FIG. 9, the serving cell is a weaker cell in this example. The transmitted first interfering signal 930 is a signal stronger than the serving signal 920. The second interfering signal 940 is also a signal stronger than the serving signal 920. The first and second interfering signals, 930, and 940, are two copies of the same transmitted signal from Cell 1 arriving at the UE via two different paths, i.e., the first and second interfering signals, 930, and 940, are the same transmission with different delays. The delay between the two paths is greater than CP. Furthermore, the signal path of the first serving signal 920 from the serving cell is aligned to the signal path of the first interfering signal 930 from Cell 1. Furthermore, in this example, Cell 1, which is the stronger cell, is transmitting an ABS subframe while the serving cell is transmitting a regular subframe. Hence, the symbols neighboring the CRS symbol are empty for the stronger cell but contain data for the weaker cell.

In an aspect, referring to FIG. 9, an end portion 950 of the received signal 910 located just outside of the FFT window, and aligned with a CRS portion 960 of the second interfering signal 940 from the stronger cell (Cell 1), can be added 990 to a front portion 970 of the received signal 910 located within the FFT window, and aligned with a blank portion 980 of the second interfering signal 940 from the stronger cell (Cell 1). By adding the end portion 950 of the received signal, the FFT window is ensured to contain full copies of the signal from the stronger cell (Cell 1). Hence, ICI from the stronger cell is removed. However, ISI for the weaker cell signal is introduced, which may be problematic dependent on the strength of the stronger cell.

In an aspect, when the Cell 1 signal is stronger, the ICI removed from the stronger cell is more than the ISI introduced. Hence, UE performance is improved. When the Cell 1 signal is not very strong, the ICI removed from the stronger cell could be less than the ISI introduced. In this case, UE performance may suffer. In an aspect, the UE may choose an appropriate scheme based on the power levels associated with the respective cells.

With reference to FIG. 9, UE gain is expected when the ICI due to the blank portion 980 of the second interfering signal 940 from the stronger cell (Cell 1) is more than the sum of ICI and ISI from the serving cell. Hence, UE gain is realized when (P_{inteferer}(2*3)*d*(1−d))>(P_{serving}*(2−d)), which happens when bias is >˜10*10 log₁₀(12)=10.77 dB. Notably, the factor 3 is due to the RS density, and the factor 2 is due to the two paths of the stronger cell (Cell 1).

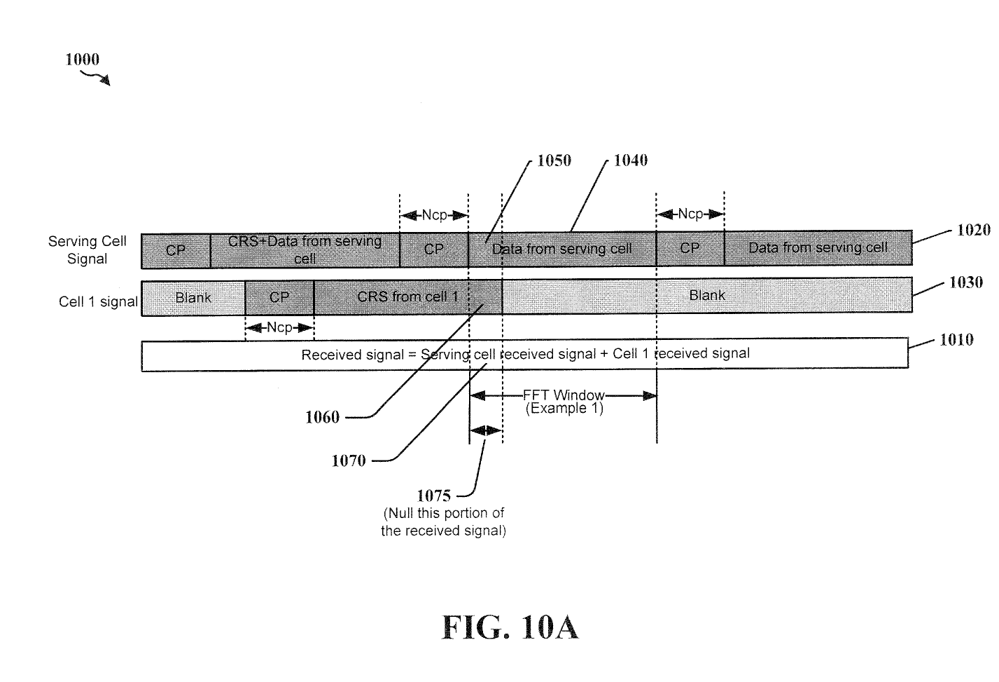

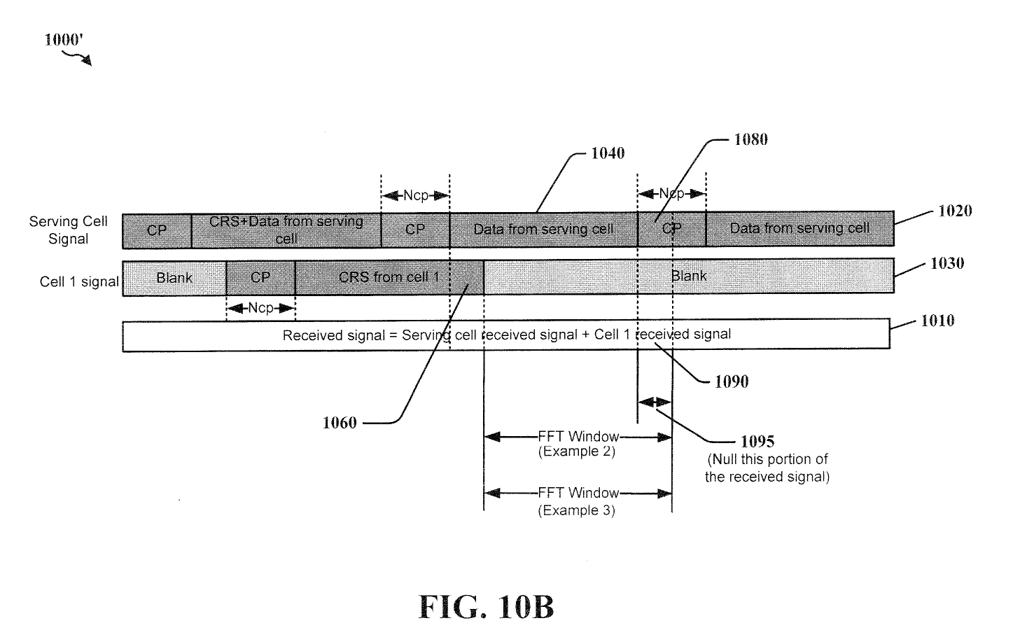

FIGS. 10A and 10B are diagrams illustrating an example of a received signal 1010. The received signal 1010 is a sum of two components. A first component is a serving signal 1020 from a serving cell and a second component is an interfering signal 1030 from Cell 1. In FIGS. 10A and 10B, the serving cell is a weaker cell in the examples. The interfering signal 1030 is stronger than the serving signal 1020. The serving signal 1020 and the interfering signal 1030 each arrive at a UE via two signal paths. However, a time offset between each path is greater than the CP. Furthermore, in the examples, Cell 1, which is the stronger cell, is transmitting an ABS subframe while the serving cell is transmitting a regular subframe. Hence, the symbols neighboring the CRS symbol are empty for the stronger cell but contain data for the weaker cell.

In an aspect, referring to diagram 1000 of FIG. 10A, Example 1, the FFT window may be positioned on the received signal 1010 to ensure that a full copy of the data region 1040 of the serving signal 1020 from the serving cell is aligned within the FFT window. However, by doing so, a portion 1050 of the data region 1040, corrupted due to its alignment with a CRS portion 1060 of the interfering signal 1030 from the stronger cell (Cell 1), is captured by the FFT window and degrades UE performance. Accordingly, a portion 1070 of the received signal 1010 which is located within the FFT window of Example 1, and aligns with the portion 1050 of the serving signal 1020 from the serving cell and the CRS portion 1060 of the interfering signal 1030 from the stronger cell (Cell 1), may be nulled or muted 1075 to improve UE gain.

In another aspect, referring to diagram 1000′ of FIG. 10B, Example 2, the FFT window may be positioned on the received signal 1010 to ensure that alignment of the FFT window is just beyond the CRS portion 1060 of the interfering signal 1030 from the stronger cell (Cell 1). However, by doing so, a CP portion 1080 of a next OFDM symbol of the serving signal 1020 is captured by the FFT window, and therefore introduces ISI from a neighboring symbol. Accordingly, a portion 1090 of the received signal 1010 which is located within the FFT window of Example 2, and aligns with the CP portion 1080 of the next OFDM symbol of the serving signal 1020, may be nulled or muted 1095 to remove the ISI from the neighboring symbol.

In a further aspect, referring to diagram 1000′ of FIG. 10B, Example 3, a typical FFT window is positioned similar to Example 2. However, no nulling (muting) is performed in case the Cell 1 is a high power interferer. For instance, the typical FFT window of Example 3 may be considered the optimal window position when the interfering cell (i.e., Cell 1) is at least six times (7.7 dB) stronger than the serving cell.

Alternatively, when the interfering cell is less than 7.7 dB stronger than the serving cell, having no ICI/ISI from the serving cell, but with ISI from the interfering cell, is more favorable to maximize UE gain. Thus, in this scenario, the FFT window is aligned with the serving cell, as in Example 1 of FIG. 10A.

For Examples 1 and 2 of FIGS. 10A and 10B, respectively, power, ISI, ICI, and signal-to-interference-and-noise ratio (SINR) may be determined as follows:

Power=P(serving cell)*(1−d)²; (18)

ISI=0; (19)

ICI=Power(serving cell)*d*(1−d); and (20)

SINR˜=(1−d)²/(d*(1−d)+(N₀/Power(serving cell))), (21)
wherein N₀ is the interference from other sources, such as thermal noise, and the like.

For Example 3 of FIG. 10B, power, ISI, ICI, SINR may be determined as follows:

Power=Power(serving cell)*(1−d)²; (22)

ISI=Power(serving cell)*d; (23)

ICI=Power(serving cell)*d*(1−d); and (24)

SINR˜=(1−d)²/(d*(2−d)+(N₀/Power(serving cell))), (25)
wherein N₀ is the interference from other sources, such as thermal noise, and the like.

In an aspect, time domain cancellation is considered. For a 2 Tx case, CRS is present only once every 3 tones. Therefore, the received samples for one OFDM symbol having a length of approximately 66 us may be split into three equal parts and combined into a single part. The combined single part may then be used to perform the FFT, channel estimation, etc. of the stronger (interfering) cell. Because the size of the FFT is reduced, the complexity of the FFTs required for time domain cancellation is reduced.

In further detail, small FFTs of size 256 for 10 MHz may be dedicated to handle interfering cells with a large timing offset. These FFTs are used to estimate and cancel interfering CRS associated with channel taps beyond CP. In operation, an OFDM symbol boundary for the small FFT may be determined according to the timing of the interfering cell. Thereafter, one OFDM symbol worth of samples having a length of 66 μs is taken. Three 22-μs segments making up the 66 μs are then folded into one 22-μs segment. FFT is performed on the one folded 22-μs segment. Channel estimation, such as descrambling, inverse FFT (IFFT), tap truncation, FFT, and scrambling may then be performed. After, IFFT and cancellation in the time domain are performed. Finally, regular receiver processing is applied. Accordingly, by the operation above, interfering channel taps with delays larger than CP are canceled. Thus, in the regular receiver processing, the OFDM symbol boundary can be aligned to the serving cell, and therefore eliminate ISI or ICI.

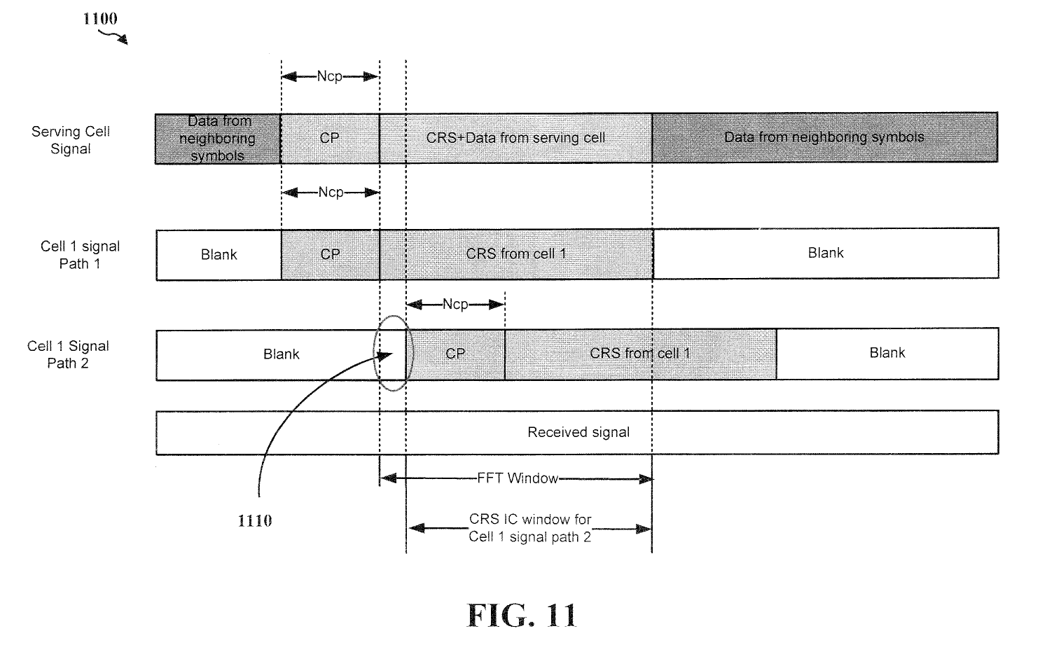

FIG. 11 is a diagram 1100 illustrating ICI mitigation. An FFT window may be positioned prior to interference cancellation (IC) of an interfering signal corresponding to an interfering channel tap with a large delay. In FIG. 11, only part of the signal path 2 from Cell 1 is within the FFT window. Once a channel delay profile is obtained, the path 2 signal should not be canceled from a portion 1110 where it was not present. Doing so will produce ICI. Accordingly, if canceling the path 2 signal from the portion 1110 where it was not present is to be performed, the cancellation should be given lower weight. For example, the interfering cell's CRS signal may be reconstructed in the frequency domain, and an IFFT may be applied to convert the signal to the time domain for cancellation.

In an aspect, a base station can help maximize UE gain. For example, the base station can transmit a longer or shorter CP, and add a post symbol postfix to an OFDM symbol by cutting neighboring symbols short on ABS subframes to mitigate the impact of a timing offset.

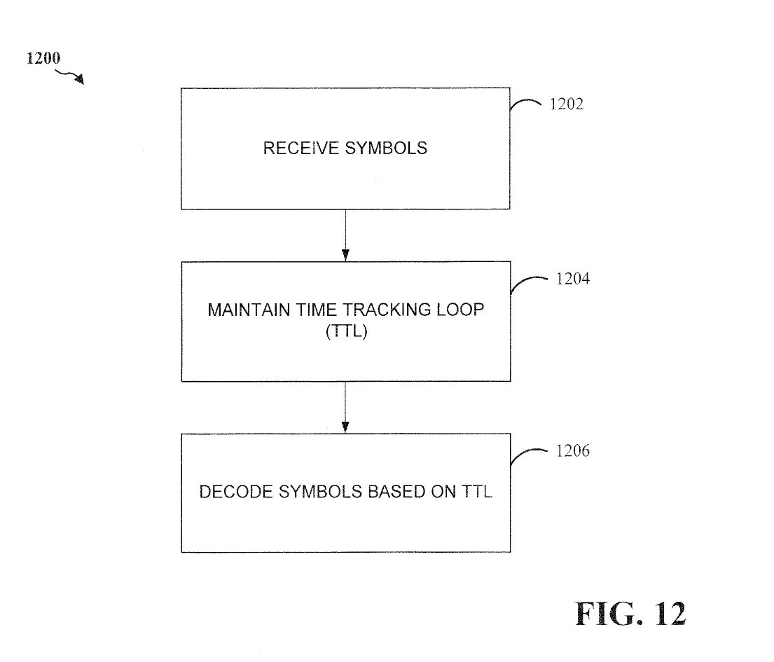

FIG. 12 is a flow chart 1200 of a method of wireless communication for updating a downlink timing for receiving signals by maintaining a time tracking loop (TTL). The TTL allows for a correct starting point of an FFT window to optimize receiver gain when decoding the received signals. The method may be performed by a UE.

At step 1202, the UE receives a signal which may include a plurality of consecutive orthogonal symbols, each symbol preceded by a cyclic prefix (CP). The symbols received may be a plurality of consecutive orthogonal frequency division multiplexing (OFDM) symbols. The signal may be received from a serving cell and at least one interfering cell. The signal may also arrive at the UE via multiple signal paths with different delays. Due to the multiple signal path delays, the signal received by the UE may be degraded due to inter-channel interference (ICI) and/or inter-symbol interference (ISI).

At step 1204, the UE maintains a TTL. The TTL optimizes UE gain by maximizing a signal-to-noise ratio (SNR). The TTL maximizes the SNR by determining an optimal FFT window position for performing the FFT on the received symbols in order to reduce ICI, reduce ISI, and/or adjust (e.g., increase) signal power in each of the received symbols based on a serving cell transmission from the serving cell and at least one interfering transmission from the at least one interfering cell.

At step 1206, the UE decodes the received symbols based on the TTL. Particularly, the UE performs the FFT on the received symbols based on the optimal window position determined. After the FFT is performed, the UE may use post-FFT samples of the symbols for further processing. In an aspect, the UE decodes the received symbols based on a common receiver fast Fourier transform (FFT) window placement determined based on the interference.

In an aspect, the symbols received by the UE are a first orthogonal frequency division (OFDM) symbol and a second OFDM symbol. The first OFDM symbol is decoded by the UE based on performing an FFT at a first FFT window starting point. The second OFDM symbol is decoded by the UE based on performing the FFT at a second FFT window starting point. Moreover, the first FFT window starting point and the second FFT window starting point correspond to different subframe timing hypotheses. In another aspect, the symbols received by the UE are a plurality of OFDM symbols received from the serving cell and the at least one interfering cell in a subframe.

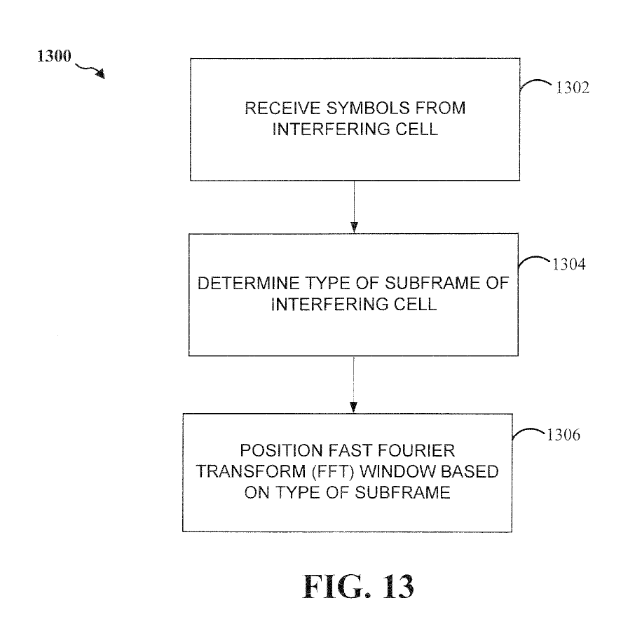

FIG. 13 is a flow chart 1300 of a method of wireless communication for maintaining the TTL. The TTL allows for a correct starting point of an FFT window to optimize receiver gain when decoding received signals. The method may be performed by the UE.

At step 1302, the UE receives a signal which may include a plurality of consecutive orthogonal symbols, each symbol preceded by a cyclic prefix (CP). The symbols received may be a plurality of consecutive orthogonal frequency division multiplexing (OFDM) symbols. The signal may be received from a serving cell and at least one interfering cell. The signal may also arrive at the UE via multiple signal paths with different delays. Due to the multiple signal path delays, the signal received by the UE may be degraded due to inter-channel interference (ICI) and/or inter-symbol interference (ISI).

At step 1304, the UE maintains the TTL by determining a type of subframe of the at least one interfering cell. For example, the subframe type of the interfering cell may be: 1) an almost blank subframe (ABS) of a multicast-broadcast single frequency network (MBSFN); 2) an ABS of a non-MBSFN; 3) a regular subframe of a MBSFN; or a regular subframe of a non-MBSFN.

At step 1306, the UE determines the FFT window position for decoding an orthogonal symbol based, at least in part, on the determined subframe type. If the subframe of the at least one interfering cell is the ABS, then the UE knows that the subframe carries CRS, but no data, and can therefore optimize the FFT window position accordingly.

In an aspect, the UE may determine the subframe type of the at least one interfering cell based, at least in part, on a first subset of the orthogonal symbols. Moreover, the UE may position the FFT window for a second subset of orthogonal symbols in the subframe. In another aspect, the FFT window position for the orthogonal symbol in the subframe is determined based on one or more of: 1) determining that the subframe type of the at least one interfering cell is the ABS; 2) a power delay profile of the serving cell and the at least one interfering cell; 3) whether the orthogonal symbol is at least one of an orthogonal symbol containing a common reference signal (CRS), an orthogonal symbol neighboring an orthogonal symbol containing CRS, or an orthogonal symbol not containing CRS and not neighboring CRS; or 4) an expected transmission from the serving cell and the at least one interfering cell in the symbol neighboring the orthogonal symbol. Whether an orthogonal symbol contains CRS may be based in part on determining whether the subframe type is an MBSFN subframe or a non-MBSFN subframe.

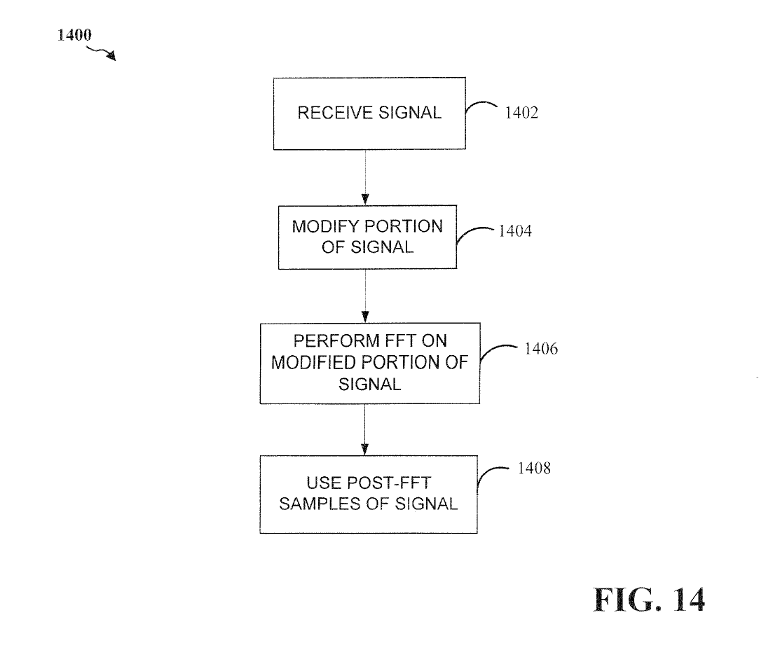

FIG. 14 is a flow chart 1400 of a method of wireless communication for modifying a received signal prior to decoding the signal in order to optimize receiver gain. The method may be performed by the UE.

At step 1402, the UE receives a signal comprising a serving cell transmission from a serving cell and at least one interfering transmission from at least one interfering cell. The serving cell transmission and the at least one interfering transmission may arrive at the UE via two signal paths with different delays. Due to the different signal path delays, the signal received by the UE may be degraded due to inter-channel interference (ICI) and/or inter-symbol interference (ISI).

At step 1404, the UE modifies a portion of the signal associated with an orthogonal symbol based on the received signal prior to performing an FFT for decoding the signal. The UE may modify the signal to reduce interference by scaling and combining different portions of the received signal. Thus, when the FFT is performed on the modified signal portion, the FFT window is able to capture more signal samples with reduced inter-symbol interference (ISI), reduced inter-carrier interference (ICI), and/or adjusted (e.g., increased) signal power.

Any two samples of the signal that are combined with non-zero scaling factors may be N chip apart, where N is a size of the FFT. Moreover, the UE determines the scaling and signal samples to combine based on a power delay profile of at least one of the serving cell or the at least one interfering cell, and information of pilot, data, control, or other transmissions from at least one of the serving cell or the at least one interfering cell.

The information of a transmission includes one or more of information of whether data is transmitted by the serving cell or the at least one interfering cell, where the data is transmitted, or an amount of power used to transmit the data. The UE may obtain the transmission information from a first subset of orthogonal symbols in a subframe and use the transmission information to determine the FFT window placement and modify samples for a second subset of orthogonal symbols in the subframe.

At step 1406, the UE performs the FFT on the modified portion of the signal. Since the FFT window captures more signal samples with reduced ISI and/or ICI, and/or increased signal power, less post-FFT samples of the signal are corrupted, and SNR is increased.

Thereafter, at step 1408, the UE uses the post-FFT samples of the signal to further process the symbol. Further processing may include demultiplexing, demodulation, and/or channel estimation, for example.

In an aspect, the UE modifies the portion of the signal by copying a portion of the signal that extends beyond the orthogonal symbol into the portion of the signal in order to reduce the ICI. The portion of the signal may include control or data of the serving cell transmission and a blank portion of the at least one interfering transmission. Moreover, the ICI may be associated with the at least one interfering transmission.

In another aspect, the UE modifies the portion of the signal by scaling the portion of the signal in order to reduce the ISI associated with at least one of the serving cell transmission or the at least one interfering transmission. Scaling the portion of the signal may include nulling the portion of the signal. Furthermore, the scaled portion of the signal may be a portion of the signal that overlaps partially with at least one of data or control of the at least one interfering transmission. Accordingly, the UE may set the FFT window between a cyclic prefix (CP) of the orthogonal symbol and a cyclic prefix of a subsequent orthogonal symbol, wherein the scaled portion of the signal is at the beginning or the end of the FFT window. Here, scaling the portion of the signal reduces the ISI associated with the at least one interfering transmission.

In yet another aspect, the scaled portion of the signal is a portion of the signal that overlaps with a subsequent orthogonal symbol of the serving cell transmission. Accordingly, the UE may set the FFT window to overlap with the orthogonal symbol and the subsequent symbol, wherein the scaled portion of the signal is at a portion of the FFT window overlapping the subsequent orthogonal symbol. Here, scaling the portion of the signal reduces the ISI associated with the serving cell transmission.

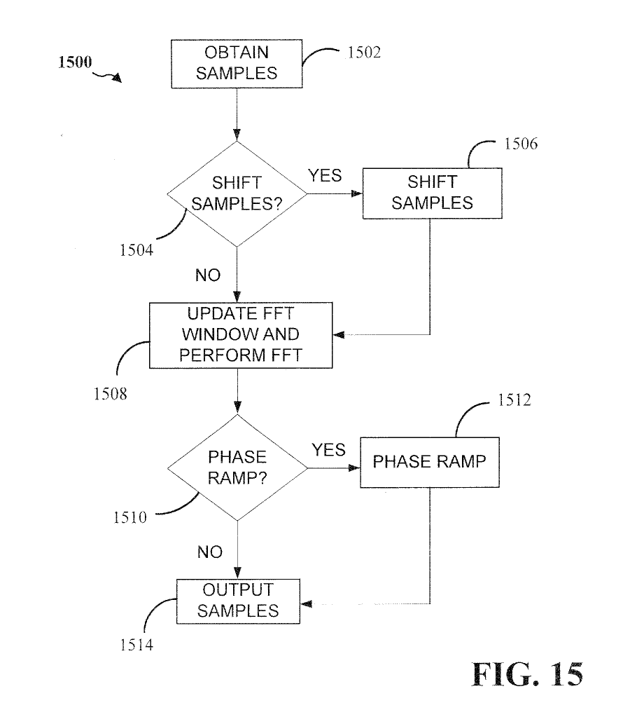

FIG. 15 is a flow chart 1500 of a method of wireless communication for maintaining the TTL. The TTL allows for a correct starting point of an FFT window to optimize receiver gain when decoding received signals. The method may be performed by the UE.

At step 1502, the UE obtains samples corresponding to at least one of a received first symbol or a received second symbol. The received symbols may be a plurality of consecutive orthogonal frequency division multiplexing (OFDM) symbols. The obtained samples are used for maintaining the TTL.

At step 1504, the UE determines whether to shift the obtained samples prior to performing the FFT at step 1508 in order to align frequency domain samples of the symbols within a subframe to a common subframe timing. If the UE determines not to shift the samples, the UE proceeds directly to step 1508.

At step 1506, based on the result of step 1604, the UE proceeds to shift the samples. By shifting the obtained samples prior to the ITT, the post-FFT frequency domain samples will be aligned to the common subframe timing.

At step 1508, the UE updates an FFT window and performs the FFT. The FFT window is updated to an optimal window position so that when the FFT is performed, ICI and/or ISI is reduced, and/or signal power is adjusted (e.g., increased), in each of the received symbols.

In an aspect, the UE updates a first FFT window starting point for performing the FFT on the first symbol based on reducing the interference or adjusting the signal power in the first symbol. Similarly, the UE updates a second FFT window starting point for performing the FFT on the second symbol based on reducing the interference or adjusting the signal power in the second symbol. In a further aspect, the first symbol may be a first OFDM symbol and the second symbol may be a second OFDM symbol, wherein the first OFDM symbol is decoded based on the first FFT window starting point, the second OFDM symbol is decoded based on the second FFT window starting point, and the first FFT window starting point and the second FFT window starting point correspond to different subframe timing hypotheses.

At step 1510, after the UE performs the FFT, the UE determines whether to phase ramp the samples in order to align frequency domain samples of the symbols within a subframe to a common subframe timing. If the UE determines not to phase ramp the samples, the UE proceeds to step 1514.

At step 1512, based on the determination at step 1510, the UE proceeds to phase ramp the samples and then proceeds to step 1514. The phase ramp may be applied to the frequency domain samples to account for the FFT window position adjustment.

At step 1514, the UE outputs the frequency domain samples for further processing. The further processing may include demultiplexing, demodulation, and/or channel estimation, for example.

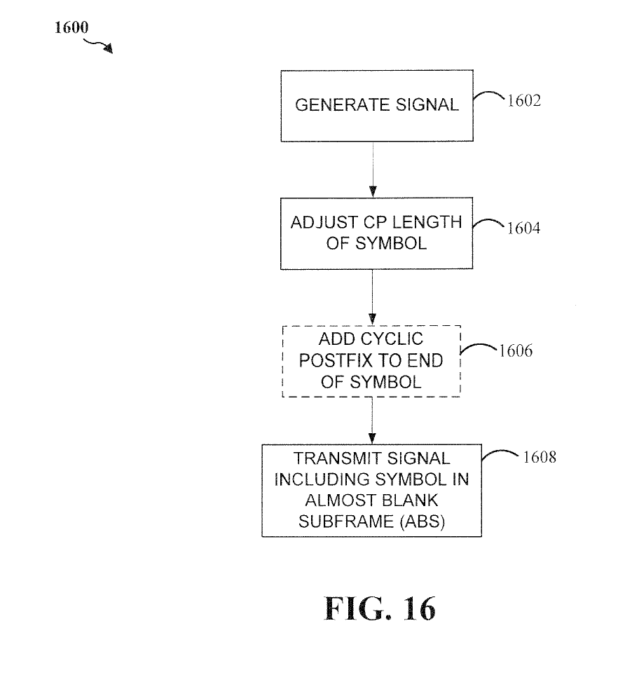

FIG. 16 is a flow chart 1600 of a method of transmitting a signal to a UE in an almost blank subframe (ABS). The method allows for mitigating a timing offset of a transmitted signal with respect to one or more signals received by the UE. The method may be performed by an eNB.

At step 1602, the eNB generates a signal. The signal may include a symbol containing a common reference signal (CRS) and a cyclic prefix (CP) associated with the symbol.

At step 1604, the eNB may adjust a length of the CP associated with the symbol. Adjusting the length of the CP results in a CP that is longer or shorter than a CP used for transmitting a signal in a non-ABS. Moreover, by adjusting the length of the CP, the signal, when transmitted by the eNB in the ABS, may have improved alignment (e.g., mitigated timing offset) with other signals received by the UE. Consequently, because of the mitigated timing offset, the UE is assisted in canceling the CRS of the symbol that may cause interference to the other signals received by the UE.

At step 1606, the eNB may also add a cyclic postfix to an end of the symbol. Similar to adjusting the CP length, by adding the cyclic postfix to the end of the symbol, the signal, when transmitted by the eNB in the ABS, may have improved alignment with the other signals received by the UE. Because of the improved alignment, the UE is assisted in canceling the CRS of the symbol that may cause interference to the other signals received by the UE.

At step 1608, the eNB transmits the signal in the ABS. The signal may include the symbol containing the CRS, and the CP associated with the symbol having the adjusted length. The transmitted signal may also include the cyclic postfix added to the end of the symbol.

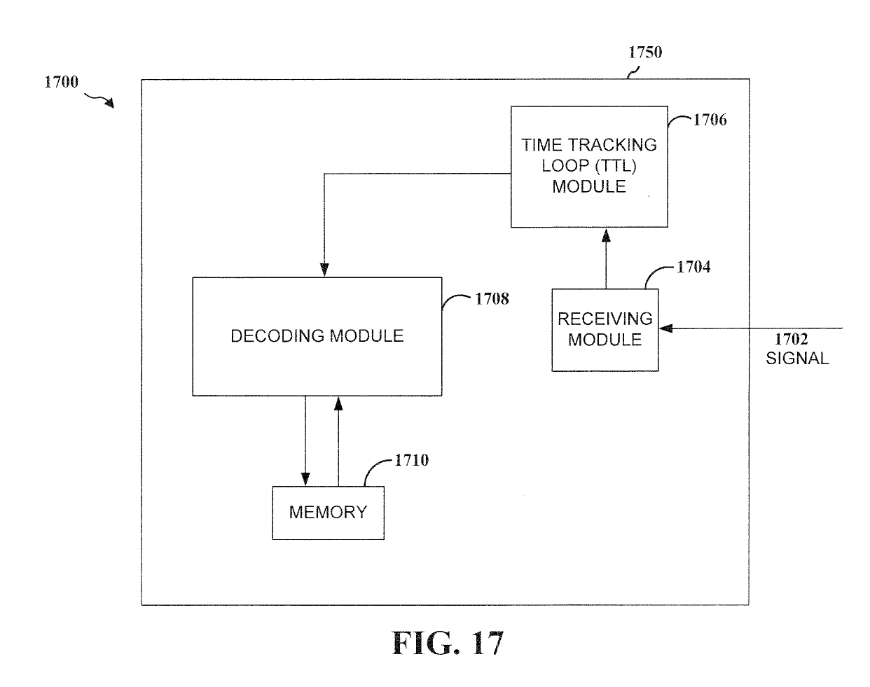

FIG. 17 is a conceptual data flow diagram 1700 illustrating the data flow between different modules/means/components in an exemplary apparatus 1750. The apparatus 1750 includes a receiving module 1704 that receives a signal 1702, a time tracking loop (TTL) module 1706 that maintains a TTL, a decoding module 1708 that decodes received data based on the TTL, and a memory 1710 that stores the decoded data.

The receiving module 1704 receives a signal which may include a plurality of consecutive orthogonal symbols, each symbol preceded by a cyclic prefix (CP). The symbols received may be a plurality of consecutive orthogonal frequency division multiplexing (OFDM) symbols. The signal may be received from a serving cell and at least one interfering cell. The signal may also arrive at the receiving module 1704 via multiple signal paths with different delays. Due to the multiple signal path delays, the signal received by the receiving module 1704 may be degraded due to inter-channel interference (ICI) and/or inter-symbol interference (ISI).

The TTL module 1706 maintains the TTL. The TTL optimizes gain by maximizing a signal-to-noise ratio (SNR). The TTL maximizes the SNR by determining an optimal FFT window position for performing the FFT on the received symbols in order to reduce ICI, reduce ISI, and/or adjust (e.g., increase) signal power in each of the received symbols based on a serving cell transmission from the serving cell and at least one interfering transmission from the at least one interfering cell.

The decoding module 1708 decodes the received symbols based on the TTL. Particularly, the decoding module 1708 performs the FFT on the received symbols based on the optimal window position determined. After the FFT is performed, the decoding module 1708 may use post-FFT samples of the symbols for further processing. In an aspect, the decoding module 1708 decodes the received symbols based on a common receiver FFT window placement determined based on the interference.

In an aspect, the symbols received by the receiving module 1704 are a first orthogonal frequency division (OFDM) symbol and a second OFDM symbol. The first OFDM symbol is decoded by the decoding module 1708 based on performing an FFT at a first FFT window starting point. The second OFDM symbol is decoded by the decoding module 1708 based on performing the FFT at a second FFT window starting point. Moreover, the first FFT window starting point and the second FFT window starting point correspond to different subframe timing hypotheses. In another aspect, the symbols received by the receiving module 1704 are a plurality of OFDM symbols received from the serving cell and the at least one interfering cell in a subframe.

In another aspect, the TTL module 1706 maintains the TTL by determining a type of subframe of the at least one interfering cell. For example, the subframe type of the interfering cell may be: 1) an almost blank subframe (ABS) of a multicast-broadcast single frequency network (MBSFN); 2) an ABS of a non-MBSFN; 3) a regular subframe of a MBSFN; or a regular subframe of a non-MBSFN. The TTL module 1706 may determine the FFT window position for decoding an orthogonal symbol based, at least in part, on the determined subframe type. If the subframe of the at least one interfering cell is the ABS, then the TTL module 1706 knows that the subframe carries CRS, but no data, and can therefore optimize the FFT window position accordingly.

In a further aspect, the TTL module 1706 may determine the subframe type of the at least one interfering cell based, at least in part, on a first subset of the orthogonal symbols. Moreover, the TTL module 1706 may position the FFT window for a second subset of orthogonal symbols in the subframe. The FFT window position for the orthogonal symbol in the subframe may be determined based on one or more of: 1) determining that the subframe type of the at least one interfering cell is the ABS; 2) a power delay profile of the serving cell and the at least one interfering cell; 3) whether the orthogonal symbol is at least one of an orthogonal symbol containing a common reference signal (CRS), an orthogonal symbol neighboring an orthogonal symbol containing CRS, or an orthogonal symbol not containing CRS and not neighboring CRS; or 4) an expected transmission from the serving cell and the at least one interfering cell in the symbol neighboring the orthogonal symbol. Whether an orthogonal symbol contains CRS may be based in part on determining whether the subframe type is an MBSFN subframe or a non-MBSFN subframe.

The TTL module 1706 may modify a portion of the signal associated with an orthogonal symbol based on the received signal prior to performing an FFT for decoding the signal. The TTL module 1706 may modify the signal to reduce interference by scaling and combining different portions of the received signal. Thus, when the FFT is performed on the modified signal portion, the FFT window is able to capture more signal samples with reduced inter-symbol interference (ISI), reduced inter-carrier interference (ICI), and/or adjusted (e.g., increased) signal power.

Any two samples of the signal that are combined with non-zero scaling factors may be N chip apart, where N is a size of the FFT. Moreover, the TTL module 1706 determines the scaling and signal samples to combine based on a power delay profile of at least one of the serving cell or the at least one interfering cell, and information of pilot, data, control, or other transmissions from at least one of the serving cell or the at least one interfering cell.

The information of a transmission includes one or more of information of whether data is transmitted by the serving cell or the at least one interfering cell, where the data is transmitted, or an amount of power used to transmit the data. The TTL module 1706 may obtain the transmission information from a first subset of orthogonal symbols in a subframe and use the transmission information to determine the FFT window placement and modify samples for a second subset of orthogonal symbols in the subframe.

The decoding module 1708 performs the FFT on the modified portion of the signal. Since the FFT window captures more signal samples with reduced ISI and/or ICI, and/or increased signal power, less post-FFT samples of the signal are corrupted, and SNR is increased. Thereafter, the decoding module 1708 uses the post-FFT samples of the signal to further process the symbol. Further processing may include demultiplexing, demodulation, and/or channel estimation, for example.

In an aspect, the TTL module 1706 modifies the portion of the signal by copying a portion of the signal that extends beyond the orthogonal symbol into the portion of the signal in order to reduce the ICI. The portion of the signal may include control or data of the serving cell transmission and a blank portion of the at least one interfering transmission. Moreover, the ICI may be associated with the at least one interfering transmission.

In another aspect, the TTL module 1706 modifies the portion of the signal by scaling the portion of the signal in order to reduce the ISI associated with at least one of the serving cell transmission or the at least one interfering transmission. Scaling the portion of the signal may include nulling the portion of the signal. Furthermore, the scaled portion of the signal may be a portion of the signal that overlaps partially with at least one of data or control of the at least one interfering transmission. Accordingly, the TTL module 1706 may set the FFT window between a cyclic prefix (CP) of the orthogonal symbol and a cyclic prefix of a subsequent orthogonal symbol, wherein the scaled portion of the signal is at the beginning or the end of the FFT window. Thus, scaling the portion of the signal may reduce the ISI associated with the at least one interfering transmission.

In yet another aspect, the scaled portion of the signal is a portion of the signal that overlaps with a subsequent orthogonal symbol of the serving cell transmission. Accordingly, the TTL module 1706 may set the FFT window to overlap with the orthogonal symbol and the subsequent symbol, wherein the scaled portion of the signal is at a portion of the FFT window overlapping the subsequent orthogonal symbol. Accordingly, scaling the portion of the signal may reduce the ISI associated with the serving cell transmission.

In an aspect, the receiving module 1702 obtains samples corresponding to at least one of a received first symbol or a received second symbol. The received symbols may be a plurality of consecutive orthogonal frequency division multiplexing (OFDM) symbols. The obtained samples are used for maintaining the TTL. The TTL module 1706 determines whether to shift the obtained samples prior to performing the FFT in order to align post-FFT frequency domain samples of the symbols within a subframe to a common subframe timing. The TTL module 1706 updates an FFT window and the decoding module 1708 performs the FFT. The FFT window is updated to an optimal window position so that when the FFT is performed, ICI and/or ISI is reduced, and/or signal power is adjusted (e.g., increased), in each of the received symbols.

In an aspect, the TTL module 1706 updates a first FFT window starting point for performing the FFT on the first symbol based on reducing the interference or adjusting the signal power in the first symbol. Similarly, the TTL module 1706 updates a second FFT window starting point for performing the FFT on the second symbol based on reducing the interference or adjusting the signal power in the second symbol. In a further aspect, the first symbol may be a first OFDM symbol and the second symbol may be a second OFDM symbol, wherein the first OFDM symbol is decoded based on the first FFT window starting point, the second OFDM symbol is decoded based on the second FFT window starting point, and the first FFT window starting point and the second FFT window starting point correspond to different subframe timing hypotheses.

After the decoding module 1708 performs the FFT, the decoding module 1708 may phase ramp the samples in order to align frequency domain samples of the symbols within a subframe to a common subframe timing. The phase ramp may be applied to the frequency domain samples to account for the FFT window position adjustment. The decoding module 1708 may then output the phase ramped samples for further processing or store the phase ramped samples in the memory 1710. The further processing may include demultiplexing, demodulation, and/or channel estimation, for example.

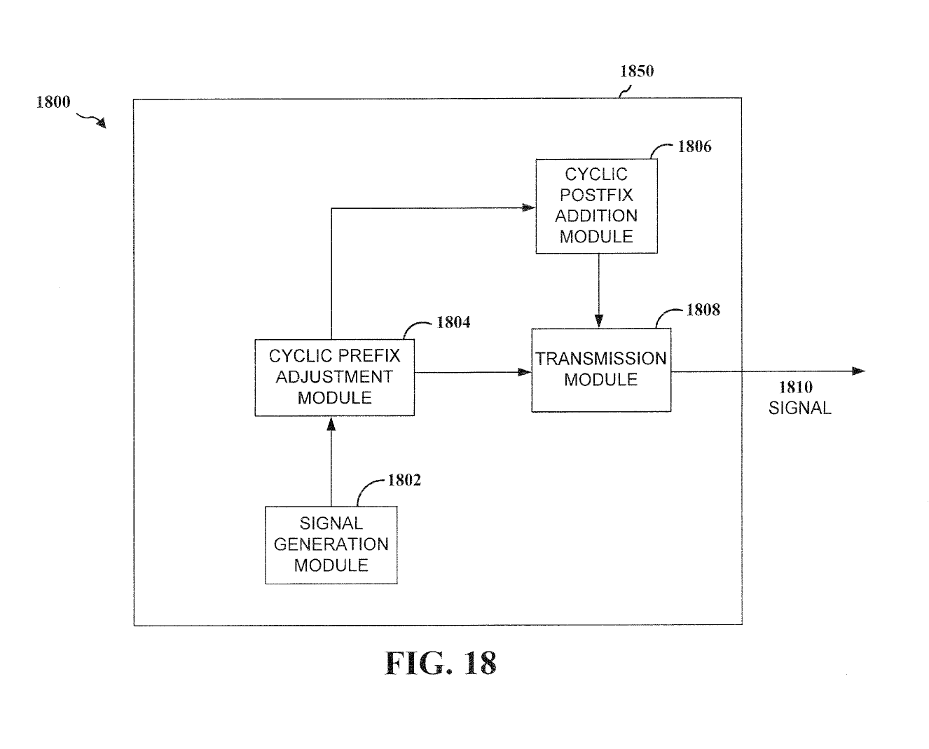

FIG. 18 is a conceptual data flow diagram 1800 illustrating the data flow between different modules/means/components in an exemplary apparatus 1850. The apparatus 1850 includes a signal generation module 1802, a cyclic prefix adjustment module 1804, a cyclic postfix addition module 1806, and a transmission module 1808.

The signal generation module 1802 generates a signal. The signal may include a symbol containing a common reference signal (CRS) and a cyclic prefix (CP) associated with the symbol.

The cyclic prefix adjustment module 1804 may adjust a length of the CP associated with the symbol. Adjusting the length of the CP results in a CP that is longer or shorter than a CP used for transmitting a signal in a regular subframe. Moreover, by adjusting the length of the CP, the signal, when transmitted by the transmission module 1808 to a UE in an almost blank subframe (ABS), may have improved alignment (e.g., mitigated timing offset) with other signals received by the UE. Consequently, because of the mitigated timing offset, the UE is assisted in canceling the CRS of the symbol that may cause interference to the other signals received by the UE.

The cyclic postfix addition module 1806 may also add a cyclic postfix to an end of the symbol. Similar to adjusting the CP length, by adding the cyclic postfix to the end of the symbol, the signal, when transmitted by the transmission module 1808 to the UE in the ABS, may have improved alignment with the other signals received by the UE. Because of the improved alignment, the UE is assisted in canceling the CRS of the symbol that may cause interference to the other signals received by the UE.

The transmission module transmits the signal 1810 in the ABS. The signal 1810 may include the symbol containing the CRS, and the CP associated with the symbol having the adjusted length. The transmitted signal 1810 may also include the cyclic postfix added to the end of the symbol.

The apparatus may include additional modules that perform each of the steps of the algorithm in the aforementioned flow charts FIGS. 12-16. As such, each step in the aforementioned flow charts FIGS. 12-16 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

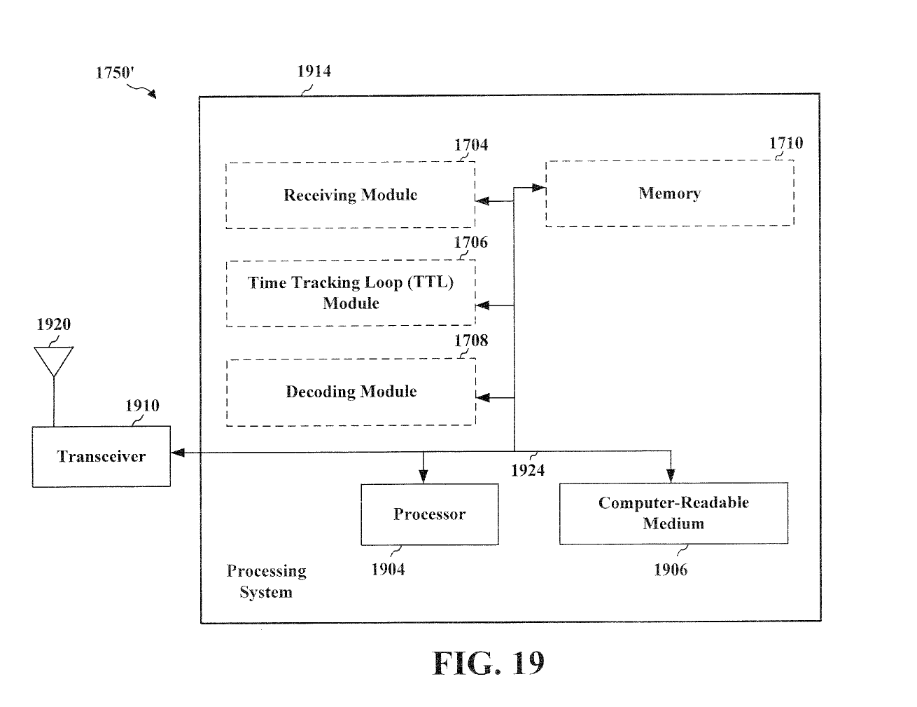

FIG. 19 is a diagram illustrating an example of a hardware implementation for an apparatus 1750′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware modules, represented by the processor 1904, the modules 1704, 1706, 1708, 1710, and the computer-readable medium 1906. The bus 1924 may also link various other circuits such as timing sources, peripherals, voltage regulators, and power management circuits, which are well known in the art, and therefore, will not be described any further.

The apparatus includes a processing system 1914 coupled to a transceiver 1910. The transceiver 1910 is coupled to one or more antennas 1920. The transceiver 1910 provides a means for communicating with various other apparatus over a transmission medium. The processing system 1914 includes a processor 1904 coupled to a computer-readable medium 1906. The processor 1904 is responsible for general processing, including the execution of software stored on the computer-readable medium 1906. The software, when executed by the processor 1904, causes the processing system 1914 to perform the various functions described supra for any particular apparatus. The computer-readable medium 1906 may also be used for storing data that is manipulated by the processor 1904 when executing software. The processing system further includes modules 1704, 1706, 1708, and 1710. The modules may be software modules running in the processor 1904, resident/stored in the computer readable medium 1906, one or more hardware modules coupled to the processor 1904, or some combination thereof. The processing system 1914 may be a component of the UE 650 and may include the memory 660 and/or at least one of the TX processor 668, the RX processor 656, and the controller/processor 659.

In a configuration, the apparatus 1750/1750′ for wireless communication includes means for receiving a signal including a plurality of consecutive orthogonal symbols from a serving cell and at least one interfering cell in a subframe, the signal comprising a serving cell transmission from the serving cell and at least one interfering transmission from the at least one interfering cell, means for maintaining a time tracking loop (TTL) by reducing interference in each of the received orthogonal symbols, means for decoding the received orthogonal symbols based on the TTL, means for modifying a portion of the signal associated with the orthogonal symbol prior to performing the FFT for decoding the signal in order to at least one of reduce inter-symbol interference (ISI), reduce inter-carrier interference (ICI), or adjust signal power in the orthogonal symbol, and means for using post-FFT samples of the signal for further processing of the orthogonal symbol.

The aforementioned means may be one or more of the aforementioned modules of the apparatus 1750 and/or the processing system 1914 of the apparatus 1750′ configured to perform the functions recited by the aforementioned means. As described supra, the processing system 1914 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

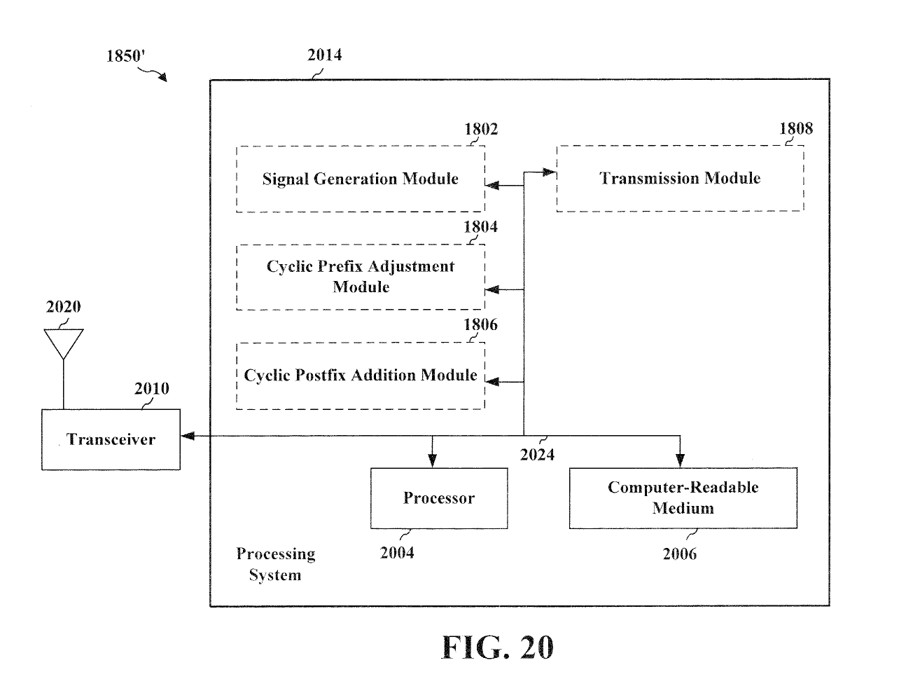

FIG. 20 is a diagram illustrating an example of a hardware implementation for an apparatus 1850′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware modules, represented by the processor 2004, the modules 1802, 1804, 1806, 1808 and the computer-readable medium 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 is coupled to one or more antennas 2020. The transceiver 2010 provides a means for communicating with various other apparatus over a transmission medium. The processing system 2014 includes a processor 2004 coupled to a computer-readable medium 2006. The processor 2004 is responsible for general processing, including the execution of software stored on the computer-readable medium 2006. The software, when executed by the processor 2004, causes the processing system 2014 to perform the various functions described supra for any particular apparatus. The computer-readable medium 2006 may also be used for storing data that is manipulated by the processor 2004 when executing software. The processing system further includes at least one of the modules 1802, 1804, 1806, and 1808. The modules may be software modules running in the processor 2004, resident/stored in the computer readable medium 2006, one or more hardware modules coupled to the processor 2004, or some combination thereof. The processing system 2014 may be a component of the eNB 610 and may include the memory 676 and/or at least one of the TX processor 616, the RX processor 670, and the controller/processor 675.

In one configuration, the apparatus 1850/1850′ for wireless communication includes means for adjusting a length of the CP associated with the symbol, means for adding a cyclic postfix to an end of the symbol, and means for transmitting the signal in the ABS, the signal including the symbol, the CP associated with the symbol having the adjusted length, and the cyclic postfix added to the end of the symbol.

The aforementioned means may be one or more of the aforementioned modules of the apparatus 1850 and/or the processing system 2014 of the apparatus 1850′ configured to perform the functions recited by the aforementioned means. As described supra, the processing system 2014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving a signal including a plurality of consecutive orthogonal symbols from a serving cell and at least one interfering cell in a subframe, the signal comprising a serving cell transmission from the serving cell and at least one interfering transmission from the at least one interfering cell;
maintaining a time tracking loop (TTL) by reducing interference in each of the received orthogonal symbols; and
decoding the received orthogonal symbols based on the TTL,
the maintaining the TTL comprising:
determining a subframe type of the at least one interfering cell, and
positioning a fast Fourier transform (FFT) window for decoding an orthogonal symbol based, at least in part, on the subframe type.

2. The method of claim 1, wherein the subframe type is one of:
an almost blank subframe (ABS) of a multicast-broadcast single frequency network (MBSFN);
an ABS of a non-MBSFN;
a regular subframe of a MBSFN; or
a regular subframe of a non-MBSFN.

3. The method of claim 1, wherein the determining is based, at least in part, on a first subset of orthogonal symbols, and wherein the positioning includes positioning the FFT window for a second subset of orthogonal symbols in the subframe.

4. The method of claim 1, wherein the FFT window position for the orthogonal symbol in the subframe is determined based on one or more of:
determining that the subframe type of the at least one interfering cell is an almost blank subframe (ABS);
a power delay profile of the serving cell and the at least one interfering cell;
whether the orthogonal symbol is at least one of an orthogonal symbol containing a common reference signal (CRS), an orthogonal symbol neighboring an orthogonal symbol containing CRS, or an orthogonal symbol not containing CRS and not neighboring CRS;
an expected transmission from the serving cell and the at least one interfering cell in the symbol neighboring the orthogonal symbol; or
whether the CRS of the at least one interfering transmission is to be canceled.

5. The method of claim 4, wherein whether an orthogonal symbol contains CRS is based in part on determining whether the subframe type is a multicast-broadcast single frequency network (MBSFN) subframe or a non-MBSFN subframe.

6. The method of claim 1, further comprising:
modifying a portion of the signal associated with the orthogonal symbol prior to performing the FFT for decoding the signal in order to at least one of reduce inter-symbol interference (ISI), reduce inter-carrier interference (ICI), or adjust signal power in the orthogonal symbol; and
using post-FFT samples of the signal for further processing of the orthogonal symbol.

7. The method of claim 6, wherein the modifying the portion of the signal comprises scaling and combining different portions of the received signal.

8. The method of claim 7, wherein any two samples of the signal that are combined with non-zero scaling factors are N chip apart, where N is a size of the FFT.

9. The method of claim 7, wherein the scaling and signal samples to combine are determined based on a power delay profile of at least one of the serving cell or the at least one interfering cell, and information of pilot, data, control, or other transmissions from at least one of the serving cell or the at least one interfering cell.

10. The method of claim 9, wherein the information of a transmission comprises one or more of information of whether data is transmitted by the serving cell and/or the interfering cell, where the data is transmitted, or an amount of power used to transmit the data.

11. The method of claim 9, wherein the information of a transmission is obtained from a first subset of orthogonal symbols in a subframe and used to determine the FFT window placement and modify the samples for a second subset of orthogonal symbols in the subframe.

12. The method of claim 6, wherein the modifying the portion of the signal comprises copying a portion of the signal that extends beyond the orthogonal symbol into the portion of the signal in order to reduce the ICI.

13. The method of claim 6, wherein the portion of the signal comprises control or data of the serving cell transmission and a blank portion of the at least one interfering transmission.

14. The method of claim 6, wherein the ICI is associated with the at least one interfering transmission.

15. The method of claim 6, wherein the modifying the portion of the signal comprises scaling the portion of the signal in order to reduce the ISI associated with at least one of the serving cell transmission or the at least one interfering transmission.

16. The method of claim 15, wherein the scaling the portion of the signal comprises nulling the portion of the signal.

17. The method of claim 15, wherein the scaled portion of the signal is a portion of the signal that overlaps partially with at least one of data, pilot, or control of the at least one interfering transmission, the method further comprising:
setting an FFT window between a cyclic prefix (CP) of the orthogonal symbol and a cyclic prefix of a subsequent orthogonal symbol, wherein the scaled portion of the signal is at the beginning or the end of the FFT window,
wherein the scaling the portion of the signal reduces the ISI associated with the at least one interfering transmission.

18. The method of claim 15, wherein the scaled portion of the signal is a portion of the signal that overlaps with a subsequent orthogonal symbol of the serving cell transmission, the method further comprising:
setting an FFT window to overlap with the orthogonal symbol and the subsequent orthogonal symbol, wherein the scaled portion of the signal is at a portion of the FFT window overlapping the subsequent orthogonal symbol,
wherein the scaling the portion of the signal reduces the ISI associated with the serving cell transmission.

19. A method of wireless communication, comprising:
receiving a signal including a plurality of consecutive symbols;
maintaining a time tracking loop (TTL) by reducing interference in each of the received symbols; and
decoding the received symbols based on the TTL,
the maintaining the TTL comprising:
updating a first fast Fourier transform (FFT) window starting point for performing the FFT on a first symbol based on the reduced interference in the first symbol,
updating a second FFT window starting point for performing the FFT on a second symbol based on the reduced interference in the second symbol, and
shifting samples, corresponding to at least one of the first symbol or the second symbol, prior to performing the FFT to align frequency domain samples of the symbols within a subframe to a common subframe timing.

20. The method of claim 19, wherein the reducing the interference in each of the received symbols is based on at least one of reducing inter-channel interference (ICI), reducing inter-symbol interference (ISI), or adjusting signal power in each of the received symbols.

21. The method of claim 19, wherein the first symbol is a first orthogonal frequency division (OFDM) symbol and the second symbol is a second OFDM symbol, the first OFDM symbol is decoded based on the first FFT window starting point, the second OFDM symbol is decoded based on the second FFT window starting point, and the first FFT window starting point and the second FFT window starting point correspond to different subframe timing hypotheses.

22. An apparatus for wireless communication, comprising:
means for receiving a signal including a plurality of consecutive orthogonal symbols from a serving cell and at least one interfering cell in a subframe, the signal comprising a serving cell transmission from the serving cell and at least one interfering transmission from the at least one interfering cell;
means for maintaining a time tracking loop (TTL) by reducing interference in each of the received orthogonal symbols; and
means for decoding the received orthogonal symbols based on the TTL,
the means for maintaining the TTL configured to:
determine a subframe type of the at least one interfering cell, and
position a fast Fourier transform (FFT) window for decoding an orthogonal symbol based, at least in part, on the subframe type.

23. The apparatus of claim 22, wherein the subframe type is one of:
an almost blank subframe (ABS) of a multicast-broadcast single frequency network (MBSFN);
an ABS of a non-MBSFN;
a regular subframe of a MBSFN; or
a regular subframe of a non-MBSFN.

24. The apparatus of claim 22, wherein the means for maintaining the TTL is further configured to determine based, at least in part, on a first subset of orthogonal symbols, and position by positioning the FFT window for a second subset of orthogonal symbols in the subframe.

25. The apparatus of claim 22, wherein the means for maintaining the TTL is further configured to determine the FFT window position for the orthogonal symbol in the subframe based on one or more of:
determining that the subframe type of the at least one interfering cell is an almost blank subframe (ABS);
a power delay profile of the serving cell and the at least one interfering cell;
whether the orthogonal symbol is at least one of an orthogonal symbol containing a common reference signal (CRS), an orthogonal symbol neighboring an orthogonal symbol containing CRS, or an orthogonal symbol not containing CRS and not neighboring CRS;
an expected transmission from the serving cell and the at least one interfering cell in the symbol neighboring the orthogonal symbol; or
whether the CRS of the at least one interfering transmission is to be canceled.

26. The apparatus of claim 25, wherein whether an orthogonal symbol contains CRS is based in part on the means for maintaining the TTL determining whether the subframe type is a multicast-broadcast single frequency network (MBSFN) subframe or a non-MBSFN subframe.

27. The apparatus of claim 22, further comprising:
means for modifying a portion of the signal associated with the orthogonal symbol prior to performing the FFT for decoding the signal in order to at least one of reduce inter-symbol interference (ISI), reduce inter-carrier interference (ICI), or adjust signal power in the orthogonal symbol; and
means for using post-FFT samples of the signal for further processing of the orthogonal symbol.

28. The apparatus of claim 27, wherein the means for modifying the portion of the signal is configured to scale and combine different portions of the received signal.

29. The apparatus of claim 28, wherein any two samples of the signal that are combined with non-zero scaling factors are N chip apart, where N is a size of the FFT.

30. The apparatus of claim 28, wherein the means for modifying a portion of the signal is configured to determine the scaling and signal samples to combine based on a power delay profile of at least one of the serving cell or the at least one interfering cell, and information of pilot, data, control, or other transmissions from at least one of the serving cell or the at least one interfering cell.

31. The apparatus of claim 30, wherein the information of a transmission comprises one or more of information of whether data is transmitted by the serving cell and/or the interfering cell, where the data is transmitted, or an amount of power used to transmit the data.

32. The apparatus of claim 30, wherein the information of a transmission is obtained from a first subset of orthogonal symbols in a subframe and used to determine the FFT window placement and modify the samples for a second subset of orthogonal symbols in the subframe.

33. An apparatus for wireless communication, comprising:
means for receiving a signal including a plurality of consecutive symbols;
means for maintaining a time tracking loop (TTL) by reducing interference in each of the received symbols; and
means for decoding the received symbols based on the TTL,
the means for maintaining the TTL configured to:
update a first fast Fourier transform (FFT) window starting point for performing the FFT on a first symbol based on the reduced interference in the first symbol,
update a second FFT window starting point for performing the FFT on a second symbol based on the reduced interference in the second symbol, and
shift samples, corresponding to at least one of the first symbol or the second symbol, prior to performing the FFT to align frequency domain samples of the symbols within a subframe to a common subframe timing.

34. An apparatus for wireless communication, comprising:
a processing system configured to:
receive a signal including a plurality of consecutive orthogonal symbols from a serving cell and at least one interfering cell in a subframe, the signal comprising a serving cell transmission from the serving cell and at least one interfering transmission from the at least one interfering cell;
maintain a time tracking loop (TTL) by reducing interference in each of the received orthogonal symbols; and
decode the received orthogonal symbols based on the TTL,
the processing system configured to maintain the TTL further configured to:
determine a subframe type of the at least one interfering cell, and
position a fast Fourier transform (FFT) window for decoding an orthogonal symbol based, at least in part, on the subframe type.

35. The apparatus of claim 34, wherein the subframe type is one of:
an almost blank subframe (ABS) of a multicast-broadcast single frequency network (MBSFN);
an ABS of a non-MBSFN;
a regular subframe of a MBSFN; or
a regular subframe of a non-MBSFN.

36. The apparatus of claim 34, wherein the processing system is configured to determine based, at least in part, on a first subset of orthogonal symbols, and position by positioning the FFT window for a second subset of orthogonal symbols in the subframe.

37. The apparatus of claim 34, wherein the processing system is configured to determine the FFT window position for the orthogonal symbol in the subframe based on one or more of:
determining that the subframe type of the at least one interfering cell is an almost blank subframe (ABS);
a power delay profile of the serving cell and the at least one interfering cell;
whether the orthogonal symbol is at least one of an orthogonal symbol containing a common reference signal (CRS), an orthogonal symbol neighboring an orthogonal symbol containing CRS, or an orthogonal symbol not containing CRS and not neighboring CRS;
an expected transmission from the serving cell and the at least one interfering cell in the symbol neighboring the orthogonal symbol; or
whether the CRS of the at least one interfering transmission is to be canceled.

38. The apparatus of claim 37, wherein whether an orthogonal symbol contains CRS is based in part on the processing system configured to determine whether the subframe type is a multicast-broadcast single frequency network (MBSFN) subframe or a non-MBSFN subframe.

39. The apparatus of claim 34, the processing system further configured to:
modify a portion of the signal associated with the orthogonal symbol prior to performing the FFT for decoding the signal in order to at least one of reduce inter-symbol interference (ISI), reduce inter-carrier interference (ICI), or adjust signal power in the orthogonal symbol; and
use post-FFT samples of the signal for further processing of the orthogonal symbol.

40. The apparatus of claim 39, wherein the processing system is configured to modify the portion of the signal by scaling and combining different portions of the received signal.

41. The apparatus of claim 40, wherein any two samples of the signal that are combined with non-zero scaling factors are N chip apart, where N is a size of the FFT.

42. The apparatus of claim 40, wherein the processing system is configured to determine the scaling and signal samples to combine based on a power delay profile of at least one of the serving cell or the at least one interfering cell, and information of pilot, data, control, or other transmissions from at least one of the serving cell or the at least one interfering cell.

43. The apparatus of claim 42, wherein the information of a transmission comprises one or more of information of whether data is transmitted by the serving cell and/or the interfering cell, where the data is transmitted, or an amount of power used to transmit the data.

44. The apparatus of claim 42, wherein the information of a transmission is obtained from a first subset of orthogonal symbols in a subframe and used to determine the FFT window placement and modify the samples for a second subset of orthogonal symbols in the subframe.

45. An apparatus for wireless communication, comprising:
a processing system configured to:
receive a signal including a plurality of consecutive symbols;
maintain a time tracking loop (TTL) by reducing interference in each of the received symbols; and
decode the received symbols based on the TTL,
the processing system configured to maintain the TTL further configured to:
update a first fast Fourier transform (FFT) window starting point for performing the FFT on a first symbol based on the reduced interference in the first symbol,
update a second FFT window starting point for performing the FFT on a second symbol based on the reduced interference in the second symbol, and
shift samples, corresponding to at least one of the first symbol or the second symbol, prior to performing the FFT to align frequency domain samples of the symbols within a subframe to a common subframe timing.

46. A computer program product, comprising:
a computer-readable medium comprising code for:
receiving a signal including a plurality of consecutive orthogonal symbols from a serving cell and at least one interfering cell in a subframe, the signal comprising a serving cell transmission from the serving cell and at least one interfering transmission from the at least one interfering cell;
maintaining a time tracking loop (TTL) by reducing interference in each of the received orthogonal symbols; and
decoding the received orthogonal symbols based on the TTL,
the code for maintaining the TTL configured to:
determine a subframe type of the at least one interfering cell, and
position a fast Fourier transform (FFT) window for decoding an orthogonal symbol based, at least in part, on the subframe type.

47. A computer program product, comprising:
a computer-readable medium comprising code for:
receiving a signal including a plurality of consecutive symbols;
maintaining a time tracking loop (TTL) by reducing interference in each of the received symbols; and
decoding the received symbols based on the TTL,
the code for maintaining the TTL configured to:
update a first fast Fourier transform (FFT) window starting point for performing the FFT on a first symbol based on the reduced interference in the first symbol,
update a second FFT window starting point for performing the FFT on a second symbol based on the reduced interference in the second symbol, and
shift samples, corresponding to at least one of the first symbol or the second symbol, prior to performing the FFT to align frequency domain samples of the symbols within a subframe to a common subframe timing.

48. A method of transmitting a signal to a user equipment (UE) in an almost blank subframe (ABS), the signal including a symbol containing a common reference signal (CRS) and a cyclic prefix (CP) associated with the symbol, comprising:
adjusting a length of the CP associated with the symbol; and
transmitting the signal in the ABS, the signal, including the symbol and the CP associated with the symbol having the adjusted length.

49. The method of claim 48, further comprising:
adding a cyclic postfix to an end of the symbol,
the signal transmitted in the ABS including the cyclic postfix added to the end of the symbol.

50. The method of claim 49, wherein the length of the CP associated with the symbol is adjusted, and the cyclic postfix is added to the end of the symbol, to mitigate a timing offset of the signal with respect to at least one other signal received by the UE.

51. An apparatus for transmitting a signal to a user equipment (UE) in an almost blank subframe (ABS), the signal including a symbol containing a common reference signal (CRS) and a cyclic prefix (CP) associated with the symbol, comprising:
means for adjusting a length of the CP associated with the symbol; and
means for transmitting the signal in the ABS, the signal including the symbol and the CP associated with the symbol having the adjusted length.

52. The apparatus of claim 51, further comprising:
means for adding a cyclic postfix to an end of the symbol,
the signal transmitted in the ABS including the cyclic postfix added to the end of the symbol.

53. The apparatus of claim 52, wherein the length of the CP associated with the symbol is adjusted, and the cyclic postfix is added to the end of the symbol, to mitigate a timing offset of the signal with respect to at least one other signal received by the UE.

54. An apparatus for transmitting a signal to a user equipment (UE) in an almost blank subframe (ABS), the signal including a symbol containing a common reference signal (CRS) and a cyclic prefix (CP) associated with the symbol, comprising:
a processing system configured to:
adjust a length of the CP associated with the symbol; and
transmit the signal in the ABS, the signal including the symbol and the CP associated with the symbol having the adjusted length.

55. The apparatus of claim 54, the processing system further configured to:
add a cyclic postfix to an end of the symbol,
the signal transmitted in the ABS including the cyclic postfix added to the end of the symbol.

56. The apparatus of claim 55, wherein the length of the CP associated with the symbol is adjusted, and the cyclic postfix is added to the end of the symbol, to mitigate a timing offset of the signal with respect to at least one other signal received by the UE.

57. A computer program product for transmitting a signal to a user equipment (UE) in an almost blank subframe (ABS), the signal including a symbol containing a common reference signal (CRS) and a cyclic prefix (CP) associated with the symbol, comprising:
a computer-readable medium comprising code for:
adjusting a length of the CP associated with the symbol; and
transmitting the signal in the ABS, the signal including the symbol and the CP associated with the symbol having the adjusted length.

58. The computer program product of claim 57, the computer-readable medium further comprising code for:
adding a cyclic postfix to an end of the symbol,
the signal transmitted in the ABS including the cyclic postfix added to the end of the symbol.

59. The computer program product of claim 58, wherein the length of the CP associated with the symbol is adjusted, and the cyclic postfix is added to the end of the symbol, to mitigate a timing offset of the signal with respect to at least one other signal received by the UE.
